(19) United States
(12) Patent Application Publication
(10) Pub. No.: US 2010/0170778 A1
(43) Pub. Date: Jul. 8, 2010

(54) PROCESS FOR THE PRODUCTION OF POLYALUMINIUM SALTS

(75) Inventors: Stig Gunnarsson, Helsingborg (SE); Marten Soderlund, Helsingborg (SE)

Correspondence Address: KNOBBE MARTENS OLSON & BEAR LLP, 2040 MAIN STREET, FOURTEENTH FLOOR, IRVINE, CA, 92614, US

(73) Assignee: KEMIRA KEMI AB, HELSINGBORG (SE)

(21) Appl. No.: 12/663,695

(22) PCT Filed: Jun. 5, 2008
(86) PCT No.: PCT/SE2008/000382

§ 371 Date: Feb. 16, 2010

(30) Foreign Application Priority Data
Jun. 8, 2007 (SE) 0701464-0

(51) Int. Cl. B01J 19/08; B01J 19/10

(52) U.S. Cl. 204/157.43; 422/186.29; 422/128

(57) ABSTRACT

The present invention relates to a process for the production of polyaluminium salts, preferably polyaluminium sulphate and polyaluminium chloride, and derivatives thereof, from aluminium containing raw materials and acids, wherein microwaves are used for partial heating of the reaction mixture. The present invention also relates to a system for the production of polyaluminium salts and derivatives thereof.

### FIELD OF THE INVENTION

The process according to present invention relates to a process and system for the production of polyaluminium salts.

### BACKGROUND TO THE INVENTION

Polyaluminium salts can be produced in several ways. One way of producing polyaluminium chloride is to dissolve aluminium metal in acidic aluminium salts, e.g. aluminium chloride or medium basicity polyaluminum chlorides. When doing this hydrogen gas is produced. The equipment used for production of polyaluminium salts with this technique must therefore be explosion proof. Aluminium metal costs considerably more per aluminium atom than aluminium in the form of other substances e.g. salts. The products produced by the process disclosed above are therefore expensive.

Another common way of producing polyaluminium chloride is to add calcium chloride and calcium carbonate or calcium hydroxide to an aqueous solution of aluminium sulphate or sulphuric acid. With this process calcium sulphate is obtained as a by-product, which is a waste product that may be very costly to discard.

As an alternative to the above described process polyaluminium chloride may be produced by digesting aluminium hydroxide in a mixture of sulphuric acid and hydrochloric acid at a temperature of about 100 to 120° C. To the formed liquid a carbonate is added whereby carbon dioxide is formed. When calcium carbonate is used solid calcium sulphate is formed that has to be separated which involves costs. If magnesium carbonate is used water soluble magnesium sulphate is formed that dilutes the polyaluminium chloride, and thus decreases the aluminium concentration of the produced product. This increases the freight costs of the produced polyaluminium chloride. If sodium carbonate is used there is a risk for the formation of sodium sulphate crystals in concentrated solutions. These crystals are quite voluminous, due to their high content of crystal water. A separation of the crystals involves costs. Further, dissolved sodium sulphate, like dissolved magnesium sulphate, dilutes the product and makes it more costly to transport.

Yet another common way of producing polyaluminium chloride is to treat a mixture with an aluminium containing material, such as aluminium hydroxide, with aqueous hydrochloric acid or aluminium chloride at about 130-170° C. under pressure. The reaction time needed for this process is in the order of 2 to 4 hours.

Attempts have been made to further shorten the reaction time by using higher production temperatures when digesting aluminium hydroxide with aqueous hydrochloric acid. EP 0554 562 discloses a method by which polyaluminium chloride, with basicities in the range 0 to 50%, is produced by digesting e.g. aluminium hydroxide, at a temperature of 140 to 250° C. for a time period of 2 to 50 minutes. By using such high reaction temperatures polyaluminium chloride can be produced faster than by the other above mentioned processes. These high temperatures were obtained by heating the reaction mixture with hot oil or hot salt solutions, steam or by electric heaters.

Polyaluminium sulphate (PAS) is available on some markets. It is sold in smaller quantities than polyaluminium chloride (PAC). PAS can be produced by adding sodium, magnesium or calcium hydroxide, or carbonate to liquid aluminium sulphate. By these production processes by-products are formed diluting the end product.

According to JP 2000-226213 polyaluminium sulphate is produced by reacting aluminium hydroxide of hydrargilit structure with sulphuric acid at 100-140° C., preferably at a pressure of 0.05-1.0 MPa, during 1-8 hours.

Problems associated with the above processes are expensive products, undesirable by products which may be costly to discard, low aluminium content in the products and for most of them long reaction times for the processes.

Also, it would be very desirable to find processes that results in poly-aluminium salts which have an increased OH/Al ratio. Polyaluminium salts with higher OH/Al ratios are more efficient in particle removal during use in water purification processes and an increased particle removal is considered advantageous.

Thus, it is very desirable to find processes that solves these problems and also to find processes that improves the OH/Al ratio.

### SUMMARY OF THE INVENTION

The present invention relates to a process for the production of polyaluminium salts and derivatives thereof, wherein an aluminium containing material is mixed with an acidic compound, and the mixture is heated to a temperature of 150-250° C. and maintained at that temperature using micro-waves, optionally in combination with another heat source, said mixture maintained at said temperature is allowed to react for a time period of about 5 seconds to 60 minutes, and thereafter the mixture is cooled to 130° C. or lower. Optionally, the mixture is subjected to ultrasound either before or during the mixture's exposure to microwaves.

The present invention also relates to a system for the production of polyaluminium salts and derivatives thereof. The system comprises a mixing device for mixing an aluminium containing material with an acidic compound to a mixture, a heating device for heating the mixture to a temperature of 150-250° C. and maintaining that temperature using microwaves, optionally in combination with one or more additional heating sources, a reactor device for reacting the mixture maintained at said temperature for a time period of about 5 seconds to 60 minutes, and a cooling device for cooling the reaction mixture down to 130° C. or lower. Optionally, the system further comprises an ultrasonic device for subjecting the mixture to ultrasound. Naturally, different ways to combine the mentioned devices are included in the design of the system, e.g. the mixing device, the heating device and optionally the ultrasonic device may be incorporated into the reactor device and/or in the vicinity of the reactor device, and specific embodiments are not to be interpreted as limiting for the scope of protection.

The present invention encompass production of polyaluminium salts, preferably polyaluminium sulphate and polyaluminium chloride and derivatives thereof, and most preferably polyaluminium chloride, from aluminium containing raw materials and acids, wherein microwaves are used for at least partial heating of the reaction mixture.

With decreasing reaction times, smaller reactor volumes are needed. Thus, it is an economical and space saving advantage with a process that can be carried out with as short reaction times as possible.

The present invention is further illustrated by the enclosed drawing which are not to be construed as limiting for the scope of the present invention.

### BRIEF DESCRIPTION OF THE DRAWING

FIGS. 1 and 2 illustrates two embodiments of the invention.

FIG. 1 shows a schematic illustration of a system with mixing and heating devices included in the reactor device.

FIG. 2 shows a schematic illustration of a system with preheating in a heating device before the reaction device which includes a second heating device, and the dotted line shows an alternative route passing by the first heating device.

### DETAILED DESCRIPTION OF THE PRESENT INVENTION

One object of the present invention is to produce polyaluminium salts with a higher molar OH/Al ratio than is obtained in conventional pressurized reactors.

Another object of the present invention is to reduce the reaction times for the production of polyaluminium salts.

By heating with microwaves polyaluminium salts with a higher molar OH/Al ratio can be produced in comparison with heating in conventional ways. Heating by microwaves also speeds up the dissolution of aluminium containing raw materials in acids, thereby reducing the reaction time.

An optional way to further decrease the reaction time is to subject solid aluminium containing material to disintegration by the use of ultrasound. Thus, the reaction time can be further shortened by reducing the particle size, whereby the surface area of the solid material is increased.

Aluminium containing materials that may be used in the present invention include, but are not limited to, e.g. various forms of aluminium hydroxides; aluminium oxide hydroxide (Boehmite); bauxite; kaolin or other,/clays; filter cakes from the etching industry; or mixtures of these materials. Preferably said aluminium containing materials regards aluminium hydroxides. The aluminium containing material preferably have a particle size of at most 500 μm, and more preferably at most 200 μm.

Acidic compounds that may be used in the present invention include, but are not limited to, e.g. hydrochloric acid, nitric acid, sulphuric acid, formic acid, aluminium chloride (e.g. aqueous) or polyaluminium salts (e.g. aqueous), with lower basicity than the product that is going to be produced by the process according to the invention, spent industrial acidic solutions, or mixtures of these. In one embodiment the acidic compound used is a mixture comprising sulphuric acid and at least one of hydrochloric acid, nitric acid, formic acid, aluminium chloride or polyaluminium chloride, with a molar OH/Al ratio being lower than the one of the final product, or spent industrial acidic solutions.

The mixture is heated by microwaves, optionally in combination with additional heat sources, to a reaction temperature of 150-250° C., preferably to 170-230° C., and most preferably to 180-220° C. and then the temperature is maintained using microwaves during the reaction of the mixture. Additional heat sources are to be interpreted as conventional heating means e.g. heat exchangers and immersion heaters. Additional heat sources and the microwave device may be connected in series, wherein the mixture is subjected to one heat treatment and then the other, or the devices are connected so that the mixture is subjected to both heat treatments at the same time. Naturally, all heating could also be done by use of microwaves only. Due to the different heating alternatives said heating device is at least one heating device.

The mixture is then allowed to react at said temperature range of 150-250° C., preferably about 170-230° C. and most preferably about 180-220° C., during a time period from 5 seconds to 60 minutes, preferably from 15 seconds to 15 minutes, preferably from 30 seconds to 10 minutes and most preferably from 2 minutes to 10 minutes. There is a correlation between temperature and reaction time, the higher the temperature is the shorter the needed reaction time becomes. During the reaction the mixture is subjected to microwaves.

In a preferred embodiment of the present invention a mixed mixture is heated conventionally to a temperature below the temperature ranges where the mixture is allowed to react, e.g. to a temperature of 130° C. Thereafter the heated mixture is further heated to the above mentioned temperatures by use of microwaves at which temperatures the mixture is allowed to react while the mixture is exposed to microwaves.

When heating a mixture by use of microwaves the heat transfer is not limited by the surface area of the reactor. By adjusting the microwave energy to the flow velocity the temperature of the mixture can be increased to the predetermined reaction temperature almost instantaneously.

By at least partially using microwaves for the heating of the mixture polyaluminium salts with a higher molar OH/Al ratio can be produced as compared to heating without the use of microwaves.

After the microwave treatment the mixture is cooled, e.g. by use of a heat exchanger. Initially the reaction mixture is cooled to a temperature of at most 130° C., preferably during a time period of at most 10 minutes, and then the reaction mixture is further cooled to about 100° C. during a time period of at most 3 hours. The heat that is released during cooling step can e.g. be utilized for increasing the temperature i.e. heating of the mixture before reaction. A switch of heat between outcoming and ingoing mixtures can e.g. be performed in a heat exchanger.

When subjecting polyaluminium salts to high temperatures non-soluble basic aluminium compounds can be formed. In order to prevent the formation of such non-soluble compounds it is important to limit the residence time at high temperatures. The formation of such non-soluble compounds is limited or eliminated by cooling the reaction mixture after the reaction.

The acidic solutions disclosed above are not to be to regarded as limiting for the present invention, other acidic solutions not specified herein can also be used. Generally one may say that the more concentrated the acid is the faster the solid aluminium containing material is dissolved.

In one embodiment of the invention the aluminium containing raw materials are disintegrated, resulting in smaller particles and a larger surface area. According to an optional embodiment of the invention such an disintegration is performed by use of ultrasound. Ultrasound creates cavitations that are beneficial for the present invention. According to the optional embodiment of the invention an ultrasonic treatment is either carried out before or during the microwave treatment, i.e. exposure to microwaves, of the waste water mixture. Preferably the mixture is subjected to ultrasound during the microwave treatment, i.e. exposure to microwaves.

The process according to the invention may e.g. be batchwise, intermittent, semi continuous or continuous. Preferably the process according to the invention is a continuous process.

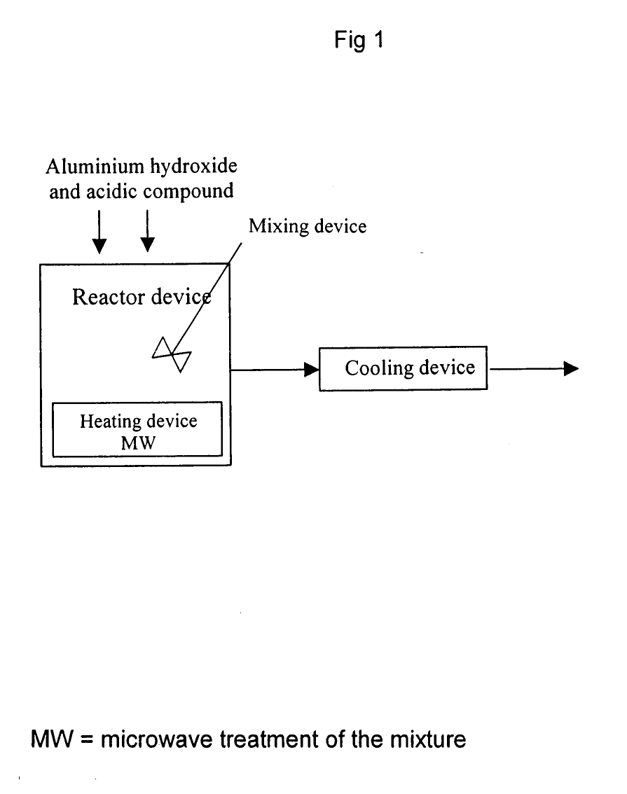

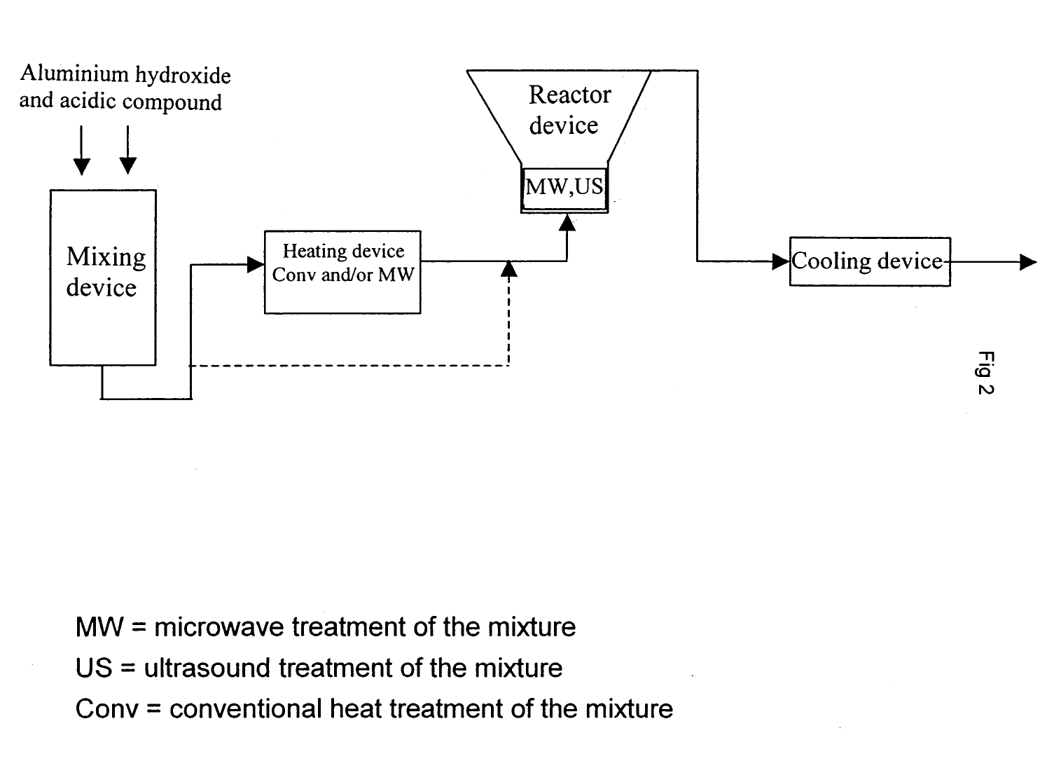

The system for the production of polyaluminium salts and derivatives thereof comprises at least one mixing device, e.g. a mixing tank or stirrer, for mixing an aluminium containing material with an acidic compound to a mixture, at least one heating device for heating and maintaining the mixture to a temperature of 150-250° C. using microwaves, optionally in combination with one or more additional heating sources, a reactor device for reacting the mixture at said temperature for a time period of about 5 seconds to 60 minutes, and a cooling device for cooling the reaction mixture down to 130° C. or lower. Optionally, the system may further comprise at least one ultrasonic device for subjecting the mixture to ultrasound. The devices of the system need not be connected in series, one embodiment is to incorporate mixing device, heating device and optionally the ultrasonic device in the reactor device or in it's vicinity. During the reaction in the reactor device the temperature is maintained in the reactor device by use of microwaves, thus at least one heating device is used, which is attached to the reactor device. Different embodiments are e.g. shown in FIGS. 1 and 2.

The present invention is further illustrated by the following examples, which are not to be construed as limiting for the scope of protection of the present invention.

### Examples

### Example 1

A 50 ml glass vessel, with a glass pocket containing a thermoelement, was filled with 50 grams of a mixture of a common commercial aluminium hydroxide and 32% hydrochloric acid. The filled sealed glass vessel was heated by an open flame or by microwaves to a temperature of 180° C. for a time period of about 3 minutes. The temperature was then kept constant for 3, 5 and 10 minutes, respectively.

The glass vessel was then cooled to about 70° C. by spraying water directly to the glass vessel. The time needed for cooling was about 5-10 minutes. The remaining solid material in the glass vessel was separated by filtering through Whatman GF/C filters. The molar OH/Al ratio of the liquid was analysed.

Table 1 illustrates the amount of aluminium hydroxide, hydrochloric acid and water added of the different samples. Table 2 illustrates the molar OH/Al ratio of the liquid phase produced after heat treatment of the different samples.

TABLE 1

| | Al(OH)₃ added with a | 32% HCl | water | starting | Al in |
|---|---|---|---|---|---|
| | water content of 1.5%. | added | added | suspension | mixture |
| No | (g) | (g) | (g) | (% solids) | (weight %) |
| 1 | 18.9 | 30.1 | 1.0 | 37.2 | 12.9 |
| 2 | ″ | ″ | ″ | ″ | ″ |
| 3 | ″ | ″ | ″ | ″ | ″ |
| 4 | 16.3 | 32.9 | 0.8 | 32.1 | 11.1 |
| 5 | ″ | ″ | ″ | ″ | ″ |
| 6 | 13.6 | 33.4 | 3.0 | 26.8 | 9.3 |
| 7 | ″ | ″ | ″ | ″ | ″ |
| 8 | ″ | ″ | ″ | ″ | ″ |

TABLE 2

| | | |
|---|---|---|
| | Molar ratio OH/Al | Molar ratio OH/Al |
| Reaction | analysed in the | analysed in the |
| time at | liquid phase | liquid phase |

| | |
|---|---|
| 180° C. | Heated by |

| No | (min) | Open flame | Microwaves |
|---|---|---|---|
| 1 | 3 | 1.04 | 1.12 |
| 2 | 5 | 1.08 | 1.16 |
| 3 | 10 | 1.24 | 1.47 |
| 4 | 5 | 0.86 | 1.09 |
| 5 | 10 | 1.07 | 1.29 |
| 6 | 3 | 0.50 | 0.78 |
| 7 | 5 | 0.75 | 0.89 |
| 8 | 10 | 0.91 | 1.12 |

From the tables it can be seen that all samples heated by microwaves had a higher molar OH/Al ratio than those heated by an open flame. Heating with microwaves thus speeds up the dissolution of aluminium hydroxide in hydrochloric acid compared to heating by an open flame. From the tables it can also be seen that the produced liquid will get an increased molar ratio OH/Al with increasing amounts of Al(OH)₃ added to the reactor.

### Example 2

A 50 ml glass vessel, with a glass pocket containing a thermoelement, was filled with 50 grams of a mixture of a common commercial aluminium hydroxide and 32% hydrochloric acid. The filled sealed glass vessel was heated by an open flame or by microwaves to a temperature of 195° C. for a time period of about 3 minutes. The temperature was then kept constant for 1 minute.

The glass vessel was then cooled to about 70° C. by spraying water directly to the glass vessel. The time needed for cooling was about 5-10 minutes. The remaining solid material in the glass vessel was separated by filtering through Whatman GF/C filters. The molar OH/Al ratio of the liquid was analysed.

Table 3 illustrates the amount of aluminium hydroxide, hydrochloric acid and water added of the different samples. Table 4 illustrates the molar OH/Al ratio of the liquid phase produced after heat treatment of the different samples.

TABLE 3

| | Al(OH)₃ added with a | 32% HCl | water | starting | Al in |
|---|---|---|---|---|---|
| | water content of 1.5%. | added | added | suspension | mixture |
| No | (g) | (g) | (g) | (% solids) | (weight %) |
| 1 | 18.9 | 30.1 | 1.0 | 37.2 | 12.9 |

TABLE 4

| | | |
|---|---|---|
| | Molar ratio OH/Al | Molar ratio OH/Al |
| Reaction | analysed in the | analysed in the |
| time at | liquid phase | liquid phase |

| | |
|---|---|
| 195° C. | Heated by |

| No | (min) | Open flame | Microwaves |
|---|---|---|---|
| 1 | 1 | 0.92 | 1.15 |

From the tables it can be seen that the sample heated by microwaves had a higher molar OH/Al ratio than the one heated by an open flame. As stated before, heating with microwaves thus speeds up the dissolution of aluminium hydroxide in hydrochloric acid compared to heating by an open flame.

1. A process for the production of polyaluminium salts, wherein an aluminium containing material is mixed with an acidic compound, and the mixture is heated to a temperature of 150-250° C. and maintained at that temperature using microwaves, optionally in combination with another heat source, said mixture maintained at said temperature is allowed to react for a time period of about 5 seconds to 60 minutes, and thereafter the mixture is cooled to 130° C. or lower.

2. Process according to claim 1, wherein the time period for reacting the mixture is about 15 seconds to 15 minutes.

3. Process according to claim 1, wherein the heat treatment using microwaves is carried out at a temperature of about 170-230° C.

4. Process according to claim 1, wherein the acidic compound is sulphuric acid, hydrochloric acid, nitric acid, formic acid, aluminium chloride or polyaluminium salts with lower basicity than the product that is going to be produced by the process according to the invention, spent industrial acidic solutions, or mixtures of these.

5. Process according to claim 4, wherein the acidic compound used is a mixture comprising sulphuric acid and at least one of hydrochloric acid, nitric acid, formic acid, aluminium chloride or polyaluminium chloride with a molar OH/Al ratio being lower than the molar OH/Al ratio of the final product, or spent industrial acidic solutions.

6. Process according to claim 1, wherein the aluminium containing material comprises aluminium hydroxides, aluminium oxide hydroxide, bauxite, kaolin or other clays, filter cakes from the etching industry, or mixtures of these materials.

7. Process according to claim 1, wherein the heat treated material is cooled to a temperature of at most 130° C. within a time period of at most 10 minutes.

8. Process according to claim 1, wherein the mixture is subjected to ultrasound either before or during the exposure to microwaves.

9. A system for the production of polyaluminium salts and derivatives thereof comprising:
a mixing device for mixing an aluminium containing material with an acidic compound to a mixture,
a heating device for heating the mixture to a temperature of 150-250° C. and maintaining that temperature using microwaves, optionally in combination with one or more additional heating sources,
a reactor device for reacting the mixture maintained at said temperature for a time period of about 5 seconds to 60 minutes, and
a cooling device for cooling the reaction mixture down to 130° C. or lower.

10. A system according to claim 9, further comprising an ultrasonic device for subjecting the mixture to ultrasound.

11. Process according to claim 1, wherein the time period for reacting the mixture is from about 30 seconds to 10 minutes.

12. Process according to claim 1, wherein the time period for reacting the mixture is from about 2 minutes to 10 minutes

13. Process according to claim 1, wherein the heat treatment using microwaves is carried out at a temperature of about 180-220° C.

14. Process according to claim 1, wherein the mixture is subjected to ultrasound during the exposure to microwaves.

15. Process according to claim 1, wherein the aluminum containing material comprises aluminum hydroxides.
